(19) United States
(12) Patent Application Publication
(10) Pub. No.: US 2006/0046007 A1
(43) Pub. Date: Mar. 2, 2006

(54) Sleeve-protected motorcycle cable or conduit sheath

(76) Inventor: Scott L. Hurwitz, Pittsford, NY (US)

Correspondence Address: BROWN & MICHAELS, PC;400 M & T BANK BUILDING, 118 NORTH TIOGA ST, ITHACA, NY, 14850, US

(21) Appl. No.: 10/929,020

(22) Filed: Aug. 27, 2004

(51) Int. Cl. B60R 21/16

(52) U.S. Cl. 428/36.1; 264/171.14; 264/78

(57) ABSTRACT

A sheath for a motorcycle cable is given a chrome-like appearance by braiding the sheath of copper wire smoothly coated with silver or tin and applying over the sheath a clear resin sleeve having an indiscernible blue or black tint. The sleeve protects the shiny and lustrous surface of the braided wire of the sheath from corrosion, tarnishing, or abrasion and also protects motorcycle parts from abrasive vibrational contact with the sheath. Tinting the sleeve saves the expense of tinting enamel coatings on each of the wires forming the braided sheath.

### TECHNICAL FIELD

Braided wire sheathing.

### BACKGROUND

My U.S. Pat. No. 5,639,527, the disclosure of which is incorporated by reference, suggests a way of giving braided cable sheathing a chrome appearance. This is done by using braiding wire having a shiny and smooth silver coating that is covered with a thin clear enamel having an indiscernible blue or black tint. The tinted enamel is coated over the braiding wires before the wires are braided into a cable or conduit sheath.

I have now discovered alternative ways of achieving the chrome appearance made possible by the '527 patent, and the alternatives have several advantages over my previous proposals. These alternatives aim at efficiency and lower cost, elimination of a previous step, avoiding abrasion of sheathing and motorcycle parts from vibrational contact, and maintaining a high-quality chrome appearance for the cable sheathing.

### SUMMARY OF INVENTION

I have found a way of maintaining sheath appearance while eliminating the tinting of the enamel coating over each individual braiding wire before it is braided into a sheath. Instead of this, I have discovered that the indiscernible blue or black tint creating an improved appearance for shiny sheathing wire can be added to an otherwise clear protective sleeve formed of flexible resin encasing a braided sheath to surround and cover the exterior of the sheath. Instead of an indiscernibly blue or black tinted enamel coated over each wire before the wires are braided into a sheath, the indiscernible blue or black tint can be applied to the protective sleeve added to the sheath after it is braided. The indiscernibly tinted clear sleeve leaves the sheath visible and gives the sheath the desired chrome appearance while also protecting both the sheath and motorcycle parts from abrasion during vibrational contact.

The sleeve can be made much thicker than an enamel coating on the individual sheath wires and can be made durable enough to keep the underlying braided sheath out of vibrational contact with parts of the motorcycle. The enameled wire sheath of my previous U.S. Pat. No. 5,639,527 does not adequately protect against vibrational contact, and the enamel on the sheath wires can quickly abrade from vibrating against motorcycle surfaces. This mars the motorcycle and makes the sheath undesirable and unattractive.

A protective resin sleeve has been used to cover a braided stainless steel sheath, but such a combination has not been given a chrome appearance. Such protective sleeves have either been clear and untinted or have been colored sufficiently to give the sleeves a noticeable color or even make them opaque so that the underlying sheath is either invisible or is viewed through a noticeably colored sleeve. A stainless steel sheath is not shiny enough to appear chrome-like, and any coloring or tinting of sleeves over stainless steel sheaths has been used only for a visible coloring effect, to make the coloring of the sleeve itself noticeable.

For my invention, tinting of the sleeve is insufficient to be noticeable when the sleeve in installed on the sheath. The sleeve tinting may be noticeable before such installation, when viewed axially for example, and the plastic from which the sleeve is formed may be noticeably blue, but once the sleeve is installed so that it is viewed radially, its tinting becomes unnoticeable. While the tinting does not noticeably color the installed sleeve, it does shift the color spectrum of the reflection from the underlying sheath so that its shiny metal appearance resembles chrome, which is much more desirable in the marketplace than a colored appearance of a protective sleeve itself.

### DRAWINGS

FIG. 1 is a partially schematic end view of a cable sheath having a covering sleeve according to the invention.

FIG. 2 is a partially schematic end view of a conduit sheath having a covering sleeve according to the invention.

FIG. 3 is a schematic diagram of a preferred way of forming an extruded sleeve over a braided cable sheath.

### DETAILED DESCRIPTION

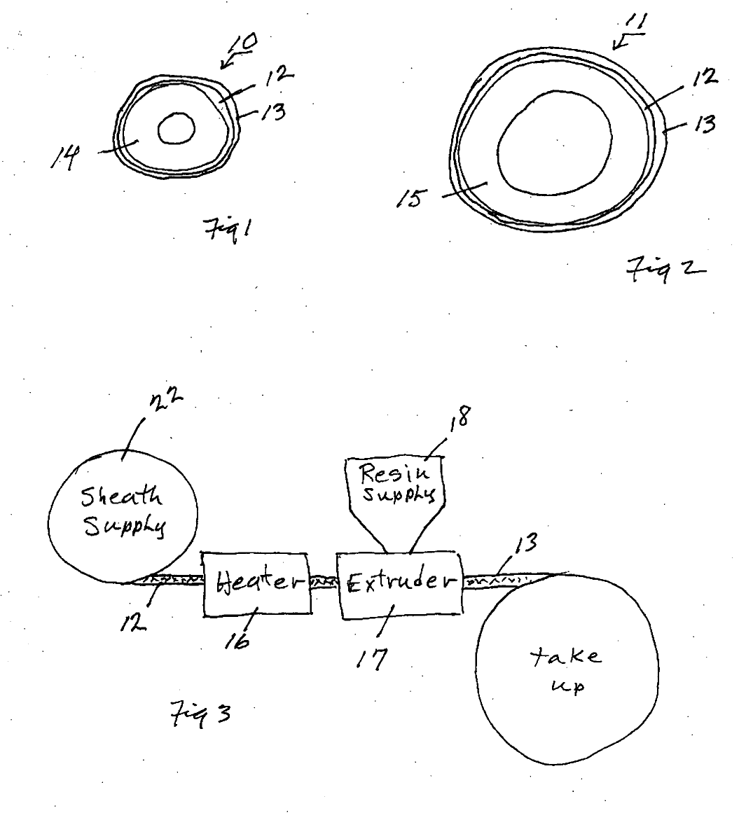

The sleeved cable sheath 10 of FIG. 1 and the sleeved conduit sheath 11 of FIG. 2 are generally similar, but differ in size and purpose. Braided wire sheath 12 of cable sheath 10 encloses a guide tube 14 within which a cable (not shown) can slide freely, and braided wire sheath 12 of conduit sheath 11 encloses a conduit 15 that can contain a fluid such as brake fluid. The use of sheaths 12 for cables and conduits is generally known in the motorcycle arts, and the inventive sleeving of such sheaths applies to both cable sheaths and conduit sheaths.

To achieve a chrome-like appearance for either of the sheaths 12, the wire used for braiding a sheath 12 is smoothly coated preferably with silver; and sleeve 13 is formed of a clear resin material lightly tinted with blue or black or a combination of blue and black coloring material in an amount that is indiscernible in sleeve 13. The tint shifts the color spectrum of light reflected from sheath 12 to a chrome appearance without making the sleeve 13 itself appear tinted to an uninformed eye.

The method of my '527 patent involved a clear enamel coating formed over each braiding wire before the wires are braided into sheath 12. Such an enamel coating was cured in an oven at about 500° F. Although a clear enamel baked onto lengths of braiding wire can be used in practicing this invention, the enameling step is not necessary to protect the wire when a sleeve will closely overlie and enclose the braided sheath. If the enameling step is omitted, sheath 12 can be braided of wire that is metal coated, but unenameled.

This change allows a substitution of tin, in some circumstances, for the preferred silver plating or coating on the braiding wire. The wire itself is preferably copper, but can also be steel or a steel alloy, such as used for “magnet” wire. A bright, shiny, and smooth coating of tin can be applied to such magnet wire to approximate, but not quite equal, the shiny wire exterior that occurs from plating or coating the wire with silver. Tin is not as stable as silver, and its originally shiny surface tends to degrade or oxidize or degrade, especially when heated. Tinned magnet wire is less expensive, though, than silver-coated magnet wire so that tinned wire makes a reasonable substitute for silver-coated wire in the present invention, which does not require a high temperature enameling process.

Stainless steel wire, which is commonly used in braided cable sheaths, has a darker and less shiny color that does not appear chrome-like when viewed through an indiscernibly blue or black tinted sleeve. Stainless steel wire is also not suitable for coating with silver or tin, and therefor is not capable of appearing chrome-like if sleeved according to my invention.

Tinned copper wire could not withstand the intense heat of an enameling oven and, therefore, was not recommended in practicing the invention of my '527 patent. A tin coating oxidizes and turns rough and gray in passing through an enameling oven. My present invention need not expose the braiding wire to temperatures as high as occur in an enameling oven so that tinned copper wire employed in the present invention and avoid oxidation, roughening, and turning gray. It is also possible by my present invention to use copper wire plated or coated with silver and covered with a thin and clear enamel on each wire to protect the silver from oxidation before the wire is braided into a sheath.

After sheath 12 is braided, and before the tin or silver coating on the sheath braiding wire can oxidize or discolor, protective sleeve 13 is applied over sheath 12. Sleeve 13 serves several functions, and the resin used for sleeve 13 must meet the requirements of each function.

Sleeve 13 protects the coated wire of sheath 12 from oxidation and discoloration so that its appearance remains bright, shiny, and attractive. Sleeve 13 is also made clear and must remain clear so that the bright attractiveness of sheath 12 is clearly visible through sleeve 13. To give the underlying sheath the appearance of chrome, sleeve 13 contains a blue/black tint that is indiscernible in sleeve 13 but is effective in making the shiny wire of sheath 12 appear chrome-like. Sleeve 13 must remain durable in a motorcycle environment where it can encounter gasoline, oil, brake fluids, and chemicals such as detergents and cleaning agents. Sleeve 13 must also avoid degradation from exposure to UV radiation, which can turn many resins cloudy or yellow and spoil their clarity. Finally, sleeve 13 prevents abrasion damage either to itself or to motorcycle parts from vibrational contact that is likely to occur between cable and conduit sheaths and motorcycles.

Several resins can provide these characteristics. One preferred resin for these purposes is fluorinated ethylene propylene (FEP), which is available in a clear form, is practically inert, and has excellent protective properties. Another preferred resin with similar properties is ethylenetetra-flouroethylene (ETFE). Another acceptable resin is perfluoralkoxy (PFA), which is also available in clear form. Another satisfactory resin is sold by DuPont under the SURLYN brand name. This is an ionomer formed by partial reaction of ethylene and acrylic acid copolymers with metallic salts. This ionomer comes in several forms that are clear, and many of these forms involve ionically cross-linked ethylene and methacrylic acid copolymers. Most of the available forms of SURLYN have a lower melting temperature than FEP, ETFE, or PFA and for this reason may not be suitable for high operating temperature environments.

Protective sleeve 13 is preferably extruded to surround and cover a braided sheath 12, as schematically shown in FIG. 3. A supply 22 of a braided cable or conduit sheath 12 is fed to an extruder 17, preferably via heater 16, which can improve an adhesion bond between sheath 12 and sleeve 13. Heater 16 preheats sheath 12 to receive a resin sleeve applied in extruder 17 to form a secure bond with the outer surface of sheath 12. When sufficient heat and pressure is used during the sleeve extrusion, the sleeve material penetrates into interstices of the sheath to strengthen and improve the bond. Such a bond between sheath 12 and extruded sleeve 13 helps protect sheath 12 from oxidation or discoloration and reduces wrinkling when a cable or conduit is bent in a tight radius, but such a bond is not necessarily essential. Sleeve 13, even if not bonded to sheath 12, substantially protects sheath 12.

Several factors make an adhesion bond between sleeve 13 and sheath 12 problematic and unnecessary. A melting adhesion bond between sleeve 13 and sheath 12 makes end-terminations more difficult. Moreover, tinned copper may not retain its shiny luster when preheated hot enough to form a melting adhesion bond with FEP or ETFE, which require extrusion temperatures of around 650-700° F. This could preclude use of tinned copper wire.

A polyethylene cable guide 14 that is typically included within cable sheath 10 may also not survive such bonding temperatures, and substituting a different and more high temperature-resistant material for guide 14 could increase the expense of the product. Silver-plated wire remains shiny and lustrous at such bonding temperatures, though, so that if guide 14 and conduit 15 can survive the sheath heating that is required for a melting adhesion bond with sleeve 13, silver-plated wire can also survive such heat.

Since sleeve 13 closely surrounds sheath 12 and tends to keep air away from the exterior of sheath 12, the protection offered by a less expensive, unbonded sleeve 13 can sometimes be adequate to preserve the shiny chrome appearance of sheath 12 Tightly crimped end-terminations can contribute to the ability of sleeve 13 to exclude air and oxidation from sheath 12 and thus preserve its shiny appearance.

Regardless of whether a bond exists between sleeve 13 and sheath 12, a slight tint is added to the resin 18 used in forming sleeve 13 in extruder 17 so that the shiny appearance of sheath 12 appears chrome-like. The tint preferred is blue, black, or a mixture or combination of blue and black. The tint can be noticeable in resin 18 and in an end view of an extruded sleeve 13, but the tint is insufficient to be noticed when the sleeve is viewed radially as happens when the sleeved cable or conduit is installed on a motorcycle. The tint thus changes the appearance of sheath 12 without becoming noticeable in sleeve 13.

To accomplish this unnoticeable tinting effect, it is important to control the thickness of sleeve 13. With a resin having a predetermined tint, a sleeve made too thin will be ineffective in tinting the sheath, and a sleeve made too thick will noticeably appear tinted itself. I prefer that sleeve thickness be in a range of from 0.005 to 0.013 inches, and within this range I prefer that sleeve 13 be 0.006 to 0.008 inches thick.

End terminations are desirable to prevent air from entering between end regions of sleeves 13 and sheaths 12, which could cause discoloration of sheaths 12. The tubular and heat-shrinkable sleeve material 13 is pretinted with a blue color that is indiscernible in the installed sleeve and that gives the shiny metal exterior of sheaths 12 a chrome appearance. Materials preferred for heat-shrinkable sleeves 13 include resins that do not degrade or yellow from exposure to UV radiation, such as FEP, ETFE, and PFA.

The tinting of sleeve 13 to enhance a chrome appearance of underlying sheath 12 differs from my '527 patent by applying the tint to the resin of sleeve 13, rather than to the enamel coating on each wire before braiding of sheath 12. Properly tinted resin will appear blue or blue/black before it is extruded and an extruded sleeve 13, before it is installed on a sheath 12 can have a noticeable tint, but once sleeve 13 is installed on sheath 12, it is no longer discernibly tinted. Instead, the shiny silvery wire of sheath 12 underneath sleeve 13 has a chrome color appearance.

I claim:

1. A combination of a motorcycle cable or conduit sheath and a guard sleeve, the sheath being braided of wire having a shiny and smooth coating of silver or tin and the sleeve surrounding and covering over an exterior of the braided sheath, the combination comprising:
a. the sleeve being formed of a substantially clear resin making the braided wire of the sheath visible through the sleeve;
b. the sleeve being tinted with a coloring material from the group consisting of blue, black, and a combination of blue and black in an amount insufficient for the coloring material to be noticeable in the sleeve; and
c. the sleeve having a thickness in a range of from 0.005 to 0.013 inches.

2. The combination of claim 1 wherein the sleeve is formed of a resin that is flexible and durably clear against heat, sunlight, gasoline, motor oil, brake fluids, chemicals and detergents encountered by motorcycles.

3. The combination of claim 1 wherein the sleeve is extruded over the sheath.

4. The combination of claim 3 wherein the sleeve penetrates interstices of the sheath.

5. A motorcycle cable or conduit sheath comprising:
a. a sleeve surrounding and covering over an exterior of the sheath;
b. the sleeve being formed of a clear resin tinted with a coloring material selected from the group consisting of blue, black, and a combination of blue and black in an amount insufficient to be noticeable in the sleeve when the sleeve is viewed radially;
c. the sheath being braided of wire having a shiny and smooth coating of silver or tin, and the sheath being visible through the resin sleeve; and
d. the sleeve having a thickness in a range of from 0.006 to 0.008 inches.

6. The sheath of claim 5 wherein the sleeve is formed of a resin that is flexible and durably clear against heat, sunlight, gasoline, motor oil, brake fluids, chemicals and detergents encountered by motorcycles.

7. The sheath of claim 5 wherein the sleeve is extruded over the sheath.

8. The sheath of claim 7 wherein the sleeve penetrates interstices of the sheath.

9. A method of tinting a motorcycle cable or conduit sheath formed of braided wire having a shiny and smooth coating of silver or tin, the method comprising:
a. extruding a clear resin sleeve over the sheath so that the sheath is visible through the sleeve;
b. setting a thickness for the sleeve of from 0.005 to 0.013 inches; and
c. tinting the resin used in extruding the sleeve with a coloring material from the group consisting of blue, black, and a combination of blue and black in an amount insufficient to be noticeable in the sleeve when the sleeve is viewed radially.

10. The method of claim 9 including heating the sheath before extruding the resin.

11. The method of claim 9 including setting the thickness of the sleeve from 0.006 to 0.008 inches.

12. The method of claim 9 including using sufficient heat and pressure to make the sleeve penetrate interstices of the sheath.
